(19) United States
(12) Patent Application Publication
(10) Pub. No.: US 2010/0031543 A1
(43) Pub. Date: Feb. 11, 2010

(54) Systems for faux wood burning heating apparatuses, faux wood burning heating apparatuses and inserts for faux wood burning heating apparatuses producing realistic looking faux fire effects, and methods of emulating a wood burning heating apparatus

(76) Inventors: James Rice, North Tustin, CA (US); Joshua Hsu, Long Beach, CA (US)

Correspondence Address: CHRISTIE, PARKER & HALE, LLP, PO BOX 7068, PASADENA, CA, 91109-7068, US

(21) Appl. No.: 12/221,710

(22) Filed: Aug. 5, 2008

(51) Int. Cl. G09F 19/00; F24B 1/18

(52) U.S. Cl. 40/428; 126/500

(57) ABSTRACT

A faux wood burning heating apparatus is provided which includes a chamber having an opening for providing viewing access to the chamber, an opening for emitting a first curtain of mist in the chamber, a log in the chamber, and a light source for projecting a colored light on the curtain. The heating apparatus may be provided as an insert for incorporating in an opening. Moreover a system may be provided for creating the faux wood burning heating apparatus. A method for emulating a wood burning heating apparatus is also provided.

### BACKGROUND OF THE INVENTION

The present invention is directed to faux wood burning heating apparatuses such as fireplaces or stoves capable for producing realistically looking flames using water vapor, steam or fog and to inserts or systems that can modify existing fireplaces and/or stoves to produce realistic looking flames using water vapor, steam or fog.

Fireplaces and stoves are desirable because of the ambiance they produce. Wood burning fireplaces and stoves are becoming less and less desirable because of their particulate emissions which are hazardous to the environment. In an effort to reduce such emissions, many fireplaces and stoves have been produced that use gas to generate flames around ceramic logs which are rested on a grate. The use of gas also has certain hazards associated with it as, for example, the production of lethal carbon monoxide. In addition, the combustion chamber of such fireplaces and stoves tends to get very hot, providing a burning hazard. Consequently, fireplaces or stoves are required that can produce realistic looking flames without the disadvantages provided by existing gas fireplaces and stoves.

### SUMMARY OF THE INVENTION

In an exemplary embodiment, a faux wood burning heating apparatus is provided which includes a chamber having an opening for providing viewing access to the chamber, an opening for emitting a first curtain of mist in the chamber, a log in the chamber, and a light source for projecting a colored light on the curtain. In another exemplary embodiment, the apparatus includes a mist producing source producing the mist that is delivered to the opening. In yet a further exemplary embodiment, the mist producing source may be a vapor generator, a steam generator, an ultrasonic humidifier, or a fogger. The apparatus in another exemplary embodiment may include a fluid reservoir within the chamber and coupled to the mist producing device for storing a fluid such as water used by the mist producing device for producing the mist forming the first curtain of mist. In one exemplary embodiment, the mist producing source is in the apparatus. In yet a further exemplary embodiment, a light source is provided within the log. In yet another exemplary embodiment, the log is semi-transparent. A faux ember bed below the log may also be provided and a light source may be provided to light the faux ember bed. In another exemplary embodiment, a blower is also provided for producing a flow of air for disturbing the first curtain of mist. In yet another exemplary embodiment a second opening is provided for emitting a second curtain of mist spaced apart from said first curtain of mist. Another light source may also be provided for projecting a colored light on the second curtain of mist. In yet a further exemplary embodiment, a heater may be provided in the apparatus. In one exemplary embodiment, the apparatus also includes a plenum formed adjacent to a chamber, a heater in the plenum for heating air in the plenum, and a blower for blowing the heated air out of said plenum. A grate may also be provided in the chamber with any of the aforementioned exemplary embodiments for supporting the log.

In a further exemplary embodiment, a faux wood burning heating apparatus is provided having a chamber having an opening for providing viewing access to the chamber, a mist producing source in the chamber for producing a curtain of mist, a grate, in the chamber, a log at least a portion of which is semi-transparent supported by the grate, a first light source within the log, a blower for generating an air flow for disturbing the curtain, a second light source for projecting a colored light on the curtain, a faux ember bed below the log, and a third light source for lighting the ember bed. Each of the aforementioned exemplary embodiment apparatuses may be inserts for insertion into an opening in a room or in an opening such as a combustion chamber of a wood burning heating apparatus such as a fireplace or stove.

In another exemplary embodiment, a method for emulating an operating wood burning heating apparatus is provided. The method includes providing a chamber, providing at least a log on the chamber, generating curtain of mist, and projecting a colored light on the curtain for emulating a color of a flame. The method may also include disturbing the curtain. In another exemplary embodiment, the method further includes striking at least one log of the at least a log with the curtain of mist.

### BRIEF DESCRIPTION OF THE DRAWINGS

FIG. 1 is a cutaway side view of an exemplary embodiment faux wood burning heating apparatus of the present invention.

FIG. 2 is a cutaway top view of the apparatus shown in FIG. 1.

FIG. 3 is a front view of the apparatus shown in FIG. 1.

### DETAILED DESCRIPTION OF THE INVENTION

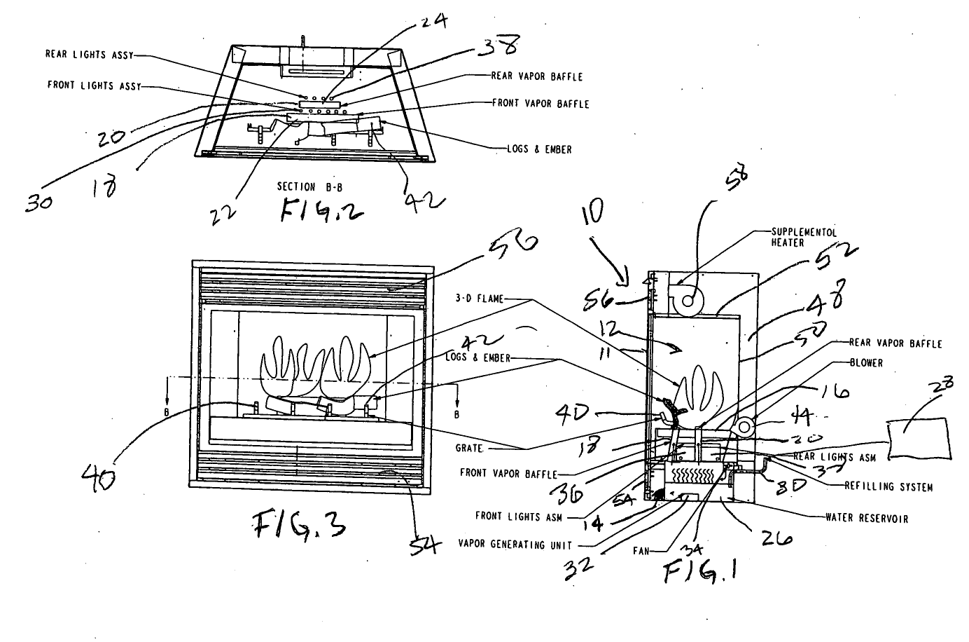

Referring to FIG. 1, in an exemplary embodiment, a faux wood burning heating apparatus such as a fireplace 10 or stove (hereinafter individually or collectively referred as a “fireplace”) is provided having a chamber 12 which is formed to mimic a fireplace combustion chamber which for descriptive purposes it is referred to herein as the “combustion chamber”. “Faux wood burning heating apparatus” as used herein refers to an apparatus which does not necessarily emit any heat and which is not necessarily used to burn real wood but which provides the appearance as thought it is an actual wood burning apparatus that is typically used to produce heat, as for example a wood burning fireplace or stove. The combustion chamber has a front opening 11 that may be covered with a glass door through which the faux flames produced by the fireplace may be viewed. A generator 14 is provided either in the combustion chamber or proximate the combustion chamber. The generator may be a vapor generator, a steam generator or a fog generator. For illustrative purposes the generator is described herein as a vapor generator. In an exemplary embodiment, as shown in FIG. 1, the generator 14 is provided below a floor 16 of the combustion chamber.

The generator includes baffles 18 and 20 which are chutes for emitting the vapor (steam or fog) produced by the vapor generator. These chutes are slender as best seen in FIG. 2 in that they each define an emitting opening 22 and 24, respectively, that is long with a narrow width. In this regard, the vapor is emitted through each of these baffles as a curtain of vapor. The baffles extend to or above the floor 16 of the chamber. For convenience the word “mist” used herein for referring to vapor, steam, and fog, collectively or individually.

A reservoir 26 to hold water is provided. The reservoir may be a separate unit or may be part of the vapor generator 14 as shown in FIG. 1. In the shown exemplary embodiment the water reservoir together with the baffles 18 and 20 define the vapor generator. In the shown exemplary embodiment, the water reservoir is coupled to an external water source 28 via a water feed 30 for receiving water. An automated system may be provided that automatically turns the water source or the water feed on when the water level drops below a first desired level and turns it off when the water level fills to a second desired level. Alternatively manual control may be provided for turning the water supplied to the water reservoir on or off. In yet another exemplary embodiment, the reservoir may be provided with an inlet that allows for filing with water manually. In other words, the inlet is not connected to a water source with this embodiment.

A vapor generating unit 32 is provided inside the water reservoir for producing vapor from the water in the water reservoir. In an exemplary embodiment, the vapor generating unit may be submerged in the water. The vapor generating unit is coupled to a power source. In other exemplary embodiments, instead of a vapor generating unit, a steam generating unit, a ultrasound humidifier unit, or a fog generating unit is used instead of the vapor generating unit. For example in one exemplary embodiment, an ultrasonic fog generator is used as the generating unit which is manufactured by Mico Inc. of El Monte, Calif. If a vapor generating unit is used, vapor will be produced. If a steam generating unit is used, steam will be produced. If an ultrasound humidifier is used, vapor will be produced. If a fog generator is used, fog will be produced.

In an exemplary embodiment, a fan 34 or other blower may be provided inside the water reservoir above the water level for creating airflow for urging the vapor generated by the vapor generating unit through the baffles 18, 20. Lighting fixtures or assemblies for lighting the curtains of vapor emitted from the baffles may be positioned above and below the combustion chamber floor. In the shown exemplary embodiment, lighting assemblies are positioned below the combustion chamber floor which has openings or which may be perforated to allow the light generated by these fixtures to light the vapor curtains. More specifically, in an exemplary embodiment, a first lighting assembly 36 is positioned behind the first baffle 18 and a second light assembly 38 is positioned behind the second baffle 20. Each lighting assembly may include a single or multiple light sources. Each light source of each assembly may include a light with color gels or lens or may be an LED or a plurality of LEDs. The lights are directed to provide light to light the vapor curtain emitted through their respective baffle. In an exemplary embodiment, the light assemblies produce colors that are red, amber, orange and yellow.

A grate 40 is positioned on the floor 16 and extends in front of the front baffle for supporting logs 42 above the floor, as shown in FIGS. 1, 2 and 3. In the exemplary embodiments, the log are faux logs, such as ceramic logs or vacuum formed logs which are typically formed from a plastic material, and are positioned proximate the baffles. To provide for a realistic effect, one or more light sources may be incorporated into the logs so as to light an external surface of the log to provide the appearance that the log is burning. In such an exemplary embodiment, at least a portion of the log may be semi-transparent so as to light up more than the rest of the log so as to provide the appearance that it is burning. In another exemplary embodiment such light source(s) may be external of the logs and provide light to the appropriate areas of the log for providing the appearance that the log is burning. In yet another exemplary embodiment, light assemblies, in lieu of light assemblies 36 and/or 38, may be incorporating in the logs for providing light onto the vapor curtain. Alternatively additional light assemblies may be incorporated into the logs for lighting the vapor curtains along with light assemblies 36, 38. In another exemplary embodiment, a faux ember bed may be provided, for example on top of the combustion chamber floor 16 which is lit by existing or separate light assemblies to provide the appearance of a true burning ember bed. The faux ember bed may be made from the same material as the faux logs. For example they may be vacuum formed from a plastic material or they may be formed from a ceramic material. The light assemblies may include flickering lights such as flickering LEDs which are installed underneath the faux ember bed to create emulate a glowing ember bed.

In an exemplary embodiment, a blower or fan 44 is provided for providing airflow for disturbing the vapor curtains emitted through the baffles. In the shown exemplary embodiment, the blower 44 is provided rear of the baffles and the light assemblies. It should be understood that power source(s) are also provided for providing power to the vapor generator unit, the light assemblies and the fans or blowers.

In operation of the exemplary embodiment system described herein, the vapor generator unit generates a vapor in the water reservoir. The fan 34 in the water reservoir creates an airflow for inducing the vapor through the baffles. Each baffle causes the vapor to be emitted as a curtain of vapor. The light assemblies light the curtains with the appropriate colors, as for example ambers and reds providing the appearance of flames. The curtains of vapor are emitted adjacent to the logs and may even strike the logs such that the curtains are disturbed. In this regard an appearance of disturbed flames surrounding the logs is provided. Simultaneously the blower 44 provides an airflow further disturbing the curtains causing them to oscillate, providing a realistic appearance of dancing flames. In an exemplary embodiment, the blower blows at the upper portion of the vapor curtains so as to scatter some of the vapor and thus, produced scattered flames emulated by such scattered vapor. To control the height of the vapor and thus the height of the appearance of flames, a controller may be provided which would allow the user to control the amount of vapor that is generated as well as the pressure for controlling the height of the vapor curtain. For example, the latter may be accomplished by controlling the speed of the fan 34.

In the exemplary embodiment shown in FIG. 2 the rear baffle is shorter in length than the front baffle. In addition, the front baffle is positioned at an angle towards the rear of the combustion chamber. The shorter rear baffle provides a vapor curtain of shorter width while the front baffle provides a vapor curtain that is directed upward and rearward behind the logs. Applicants have discovered that this configuration aids in the emulation of realistic looking flames.

The exemplary flame emulating system described herein may be provided as a kit for retrofitting existing fireplaces. In another exemplary embodiment a combustion chamber including the system may be provided as an insert for inserting into existing fireplaces. In an exemplary embodiment, the insert is the faux heating apparatus itself which is designed for fitting in an opening in a room or device or in an existing fireplace or stove opening or combustion chamber. In yet further exemplary embodiments, the fireplace may be built to incorporate the inventive systems. In another exemplary embodiment, an exemplary embodiment fireplace of the present invention may be provided as a free-standing unit, e.g. a stove.

In another exemplary embodiment, a plenum 48 may be defined behind the combustion chamber. The plenum may at least extend behind a rear wall 50 and above a top wall 53 of the chamber or may extend only above the top wall 52. The plenum may also extend below the floor 16 of the combustion chamber. The plenum is provided with an inlet that is able to receive air from a location, as for example from the room where the fireplace is located or from a location external of the room. In the shown exemplary embodiment, the plenum extends from below, behind and on top of the chamber as for example shown in FIG. 1. The inlet 54 is located in front of the fireplace below the chamber so as to receive air from the location where the fireplace is located. An outlet 56 is located in front of the fireplace above the chamber. A heater 58 which may include a blower is placed in the plenum 58. The heater heats the air flowing through the plenum. The heated air exits the outlet 56. In an exemplary embodiment, a blower of the heater causes air to circulate though the plenum so that the air is received from the inlet 54 is heated by the heater 58 and discharged through the outlet 56 so as to heat the room where the fireplace is located. In an exemplary embodiment, the fireplace including the combustion chamber 12, the plenum 48 and the inventive system may be produced as a unit for use in forming a fireplace or as an insert for inserting into an existing fireplace.

In another extemporary embodiment, a glass plate may be incorporated in front of the front baffle for preventing wind from outside the opening 11 from disturbing the vapor curtain emitted through such baffle.

Although the present invention has been described and illustrated to respect to multiple embodiments thereof, it is to be understood that it is not to be so limited, since changes and modifications may be made therein which are within the full intended scope of this invention as hereinafter claimed. For example, in other exemplary embodiments a single or more than two baffles for emitting vapor curtains may be used. In other exemplary embodiment only a single or multiple light sources may be used. In yet further exemplary embodiments, the water reservoir or the vapor, steam or fog producing device may be external of the fireplace and the vapor, steam or fog, is provided to the fireplace with appropriate conduits that deliver the vapor, steam or fog to the baffles or as curtains at the appropriate locations.

In another exemplary embodiment, a controller may be provided to control the blowers for controlling the amount of force they provide. For example, the controller may cause the blower 44 to continuously vary its intensity so that type of disturbance it creates on the vapor curtains is varied and the type of flames that are emulated continuously vary providing the appearance of more realistic flames. In addition the blower 44 may be mounted so that it can move along the curtains, and/or up and down and/or pivot back and forth at a constant or various speeds so as to vary the disturbance it causes to the vapor curtains. In such case the controller may control such movement. Moreover, instead of one, multiple blowers may be used as necessary.

What is claimed is:

1. A faux wood burning heating apparatus comprising:
a chamber having an opening for providing viewing access to the chamber;
an opening for emitting a first curtain of mist in the chamber;
a log in the chamber; and
a light source for projecting a colored light on said curtain.

2. The apparatus as recited in claim 1 further comprising a mist producing source producing the mist that is delivered to said opening.

3. The apparatus as recited in claim 2 wherein the mist producing source is a vapor generator.

4. The apparatus as recited in claim 2 wherein the mist producing source is a steam generator.

5. The apparatus as recited in claim 2 wherein the mist producing source is an ultrasonic humidifier.

6. The apparatus as recited in claim 2 wherein the mist producing source is a fogger.

7. The apparatus as recited in claim 2 further comprising a fluid reservoir within the chamber and coupled to said mist producing device for storing a fluid used by said mist producing device for producing said mist forming said first curtain of mist.

8. The apparatus as recited in claim 2 wherein the mist producing source comprises a water reservoir and a mist generating unit in the water reservoir.

9. The apparatus as recited in claim 8 wherein said mist producing source is in said faux heating apparatus.

10. The apparatus as recited in claim 1 further comprising a light source within said log.

11. The apparatus as recited in claim 10 wherein at least a portion of said log is semi-transparent.

12. The apparatus as recited in claim 1 further comprising a faux ember bed below said log and a light source lighting said faux ember bed.

13. The apparatus as recited in claim 1 further comprising a blower for producing a flow of air for disturbing said first curtain of mist.

14. The apparatus as recited in claim 1 further comprising a second opening for emitting a second curtain of mist spaced apart from apart from said first curtain of mist.

15. The apparatus as recited in claim 14 further comprising another light source for projecting a colored light on said second curtain of mist.

16. The apparatus as recited in claim 1 further comprising a heater in said heating apparatus.

17. The apparatus as recited in claim 1 further comprising;
plenum formed adjacent said chamber;
a heater in the plenum for heating air in the plenum; and
a blower for blowing said heated air out of said plenum.

18. The apparatus as recited in claim 1 further comprising a grate in said chamber supporting said log.

19. A faux wood burning heating apparatus comprising:
a chamber having an opening for providing viewing access to the chamber;
a mist producing source in said chamber for producing a curtain of mist;
a grate in the chamber;
a log at least a portion of which is semi-transparent supported by said grate;
a first light source within said log;
a blower for generating an air flow for disturbing the curtain;
a second light source for projecting a colored light on said curtain;
a faux ember bed below said log; and
a third light source for lighting said ember bed.

20. A method for emulating an operating wood burning heating apparatus, the method comprising:
providing a chamber;
providing a least a log on said chamber;
generating curtain of mist; and
projecting a colored light on said curtain for emulating a color of a flame.

21. The method as recited in claim 20 further comprising disturbing said curtain.

22. The method as recited in claim 20 comprising striking at least one log of said at least a log with said curtain of mist.
